(19) United States
(12) Patent Application Publication
(10) Pub. No.: US 2007/0057872 A1
(43) Pub. Date: Mar. 15, 2007

(54) Plasma display apparatus and driving method of the same

(75) Inventors: Yun Kwon Jung, Gumi-si (KR); Bong Koo Kang, Pohang-si (KR); Seok Ho Kim, Pohang-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/354,968

(22) Filed: Feb. 16, 2006

(30) Foreign Application Priority Data
Sep. 13, 2005 (KR) 10-2005-0085463

(51) Int. Cl. G09G 3/28

(52) U.S. Cl. 345/68

(57) ABSTRACT

The present invention relates to a plasma display apparatus, more particularly, to a plasma display apparatus and the driving method of the same for providing an improved energy recovery circuit for a sustain discharge. A plasma display apparatus according to an aspect of the present invention comprises a plasma display panel comprising a scan electrode and a sustain electrode; an energy recovery unit applying energy to the scan electrode and the sustain electrode through an energy recovery path; a first energy supply controller connecting the energy recovery unit to the scan electrode; and a second energy supply controller connecting the energy recovery unit to the sustain electrode.

This application claims the benefit of Korean Patent Application No. 10-2005-0085463, filed on Sep. 13, 2005, which is hereby incorporated by reference for all purposes as if fully set forth herein.

### BACKGROUND OF THE INVENTION

1. Field of the Invention

This document relates to a plasma display apparatus, more particularly, to a plasma display apparatus and the driving method of the same for providing an improved energy recovery circuit for a sustain discharge.

2. Description of the Background Art

In a conventional plasma display panel, one unit cell is provided at a space between barrier ribs formed between a front panel and a rear panel. A main discharge gas such as neon Ne, helium He or a mixture He+Ne of neon and helium and an inert gas containing a small amount of xenon Xe fill each cell. When a discharge occurs using a high frequency voltage, the inert gas generates vacuum ultraviolet rays and phosphors provided between the barrier ribs are stimulated to emit light; thereby realizing an image. The plasma display panel is considered as one of the next generation display devices due to its thin and light configuration.

The plasma display panel is connected to drivers for operating the panel to implement the plasma display apparatus. The driver of the plasma display panel includes the driving part applying the pulse of the sustain voltage Vs in the sustain period. The driving part is described in detail in FIG. 1.

FIG. 1 is a drawing showing the driver for a sustain discharge in a related art plasma display panel driving.

As shown in FIG. 1, in the conventional plasma display apparatus, the driver for the sustain discharge operates the scan electrode Y and sustain electrode Z. At this time, the energy recovery circuit is used in order to collect the energy, that is, the reactive power which is gratuitously generated in the plasma display panel. FIG. 2 illustrates the drive waveform generated in the driver in FIG. 1.

In FIG. 2, in order to operate the scan electrode Y, Z SUS DN switch is turned on and the sustain electrode Z is maintained in GND level voltage from the 0 period T0 to the fourth period T4.

For applying the sustain pulse to the scan electrode Y, Y ER UP switch of FIG. 1 is turned on in the first period T1, the other switches except Y ER UP switch and Z SUS DN switch are turned off. Accordingly, the energy of the reactive power that the first capacitor Cs1 collects and stores forms the resonance between the first inductor L1 and the capacitor Cp of the panel, being supplied to the scan electrode Y to charge the panel Cp.

In the second period T2, Y ER UP switch and Y SUS UP switch are turned on, while all the other switches except Y ER UP switch, Y SUS UP switch and Z SUS DN switch are turned off. Accordingly, the voltage of the panel becomes the sustain voltage Vs. That is, when the first period T1 is finished, the voltage of the panel becomes a maximum due to the LC resonance. At that moment, the sustain voltage Vs is applied to the panel Cp. In this case, the sustain voltage Vs means the voltage for maintaining the discharge of the discharge cell in the sustain period.

Thereafter, in the third period T3, the ER DN switch is turned on, while all the other switches except the ER DN switch and Z SUS DN switch are turned off. Accordingly, while the energy stored in the panel Cp is discharged to the first capacitor Cs1 through the scan electrode Y, the energy is collected and the voltage of the panel falls.

Finally, in the fourth period T4, Y SUS DN switch is turned on, while Z SUS DN switch maintains the turn on till the latter part of the fourth period. However, all the other switches are turned off except Y SUS DN switch and Z SUS DN switch. Accordingly, the voltage of the panel becomes GND level. That is, the voltage of the both ends of panel maintains GND level from the moment when the third period T3 is finished to the fourth period T4. Therefore, there is an idle period between the driving of the scan electrode Y and driving of the sustain electrode Z.

For applying the sustain pulse to the sustain electrode Z, the scan electrode Y maintains GND level by turning on Y SUS DN switch in order to operate the sustain electrode Z, from the fourth period T4 of FIG. 2 till the seventh period T7 or till the 0 period T0 before operating the following scan electrode Y.

In the fifth period T5, Z ER UP switch of FIG. 1 is turned on and all the other switches are turned off except Z ER UP switch and Y SUS DN switch. Accordingly, the energy of the reactive power that the first capacitor Cs2 collects and stores forms the resonance between the first inductor L2 and the capacitor Cp of the panel, being supplied to the sustain electrode Z to charge the panel Cp.

In the sixth period T6, Z ER UP switch and Z SUS UP switch are turned on, while all the other switches except Z ER UP switch, Z SUS UP switch and Y SUS DN switch are turned off. Accordingly, the voltage of the panel becomes the sustain voltage Vs. That is, when the fifth period T5 is finished, the voltage of the panel becomes a maximum due to the LC resonance. At that moment, the sustain voltage Vs is applied to the panel Cp. In this case, the sustain voltage Vs means the voltage for maintaining the discharge of the discharge cell in the sustain period.

In the seventh period T7, the ER DN switch is turned on and all the other switches except the ER DN switch and Y SUS DN switch are turned off. Accordingly, while the energy stored in the panel Cp is discharged to the second capacitor Cs2 through the sustain electrode Z, the energy is collected and the voltage of the panel falls.

Then, the zero period T0 of the idle period is initiated before operating the scan electrode Y. In the zero period, Z SUS DN switch is turned on and Y SUS DN switch maintains the turn on till the latter part of the zero period. Moreover, all the other switches except Z SUS DN switch and Y SUS DN switch are turned off. Accordingly, the voltage of the panel becomes GND level. That is, the voltage of the both ends of panel maintains GND level from the moment when the third period T7 is finished to the zero period T0. Therefore, there is an idle period between the driving of the scan electrode Y and driving of the sustain electrode Z.

In the related art plasma display panel described above, the device for rectifying is necessary in order to normally operate, that is, to reduce the noise of a waveform as the drive waveform of FIG. 2. For example, the 4 diode D5, D6, D7, D8 of FIG. 1 let the input waveform to maintain the sustain voltage level Vs or the base voltage level Vs when the sustain pulse is inputted.

Moreover, in the above-described energy recovery circuit, when the energy is charged and discharged with the panel Cp by using the resonance between the capacitor Cp and the inductor L1, L2, if the direction of the current flowing in the inductor L1, L2 is suddenly changed, the counter electromotive force is generated. There is a problem in that the device is damaged if the voltage difference between the inductor L1, L2 and the panel Cp is higher than the sustain voltage level Vs due to the counter electromotive force.

Further, the device for protecting the device damage by passing the excess current toward the power source is added in a circuit. For example, the 4 diodes D1, D2, D3, D4 of FIG. 1 is installed to protect circuit elements described above.

As described above, the related art plasma display apparatus has the problem in that devices having a specific function have to be individually added for the normal circuit operation. Moreover, the related art plasma display apparatus has the problem in that switching elements are necessary for individual electrodes to operate the scan electrode Y and sustain electrode Z, thus increasing the number of devices. Hence, there is a problem in that the manufacturing cost of the driver increases when the number of devices are increased.

### SUMMARY OF THE INVENTION

Accordingly, an object of the present invention is to solve at least the problems and disadvantages of the background art.

The present invention is to provide the plasma display apparatus securing the stability of the operation of the driver. Moreover, the present invention is to provide the plasma display apparatus for simplifying a circuit by reducing the number of devices and for reducing the manufacturing cost.

A plasma display apparatus according to an aspect of the present invention comprises a plasma display panel comprising a scan electrode and a sustain electrode; an energy recovery unit applying energy to the scan electrode and the sustain electrode through an energy recovery path; a first energy supply controller connecting the energy recovery unit to the scan electrode; and a second energy supply controller connecting the energy recovery unit to the sustain electrode.

A method of driving plasma display apparatus according to another aspect of the present invention comprises applying energy stored in a common capacitor of an energy recovery part to a scan electrode through an inductor of the energy recovery part; applying a sustain voltage to the scan electrode from a scan voltage source; storing energy into the common capacitor of the energy recovery part by recovering energy applied in the scan electrode; and applying energy stored in the common capacitor of the energy recovery part to the sustain electrode through the inductor of the energy recovery part.

The plasma display apparatus according to the present invention has the effect that the stability of the operation of the driver circuit is improved. Moreover, the plasma display apparatus has the effect that the circuit is simplified by reducing the number of devices and the manufacturing cost is saved.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention. In the drawings:

FIG. 1 is a drawing showing the driver for a sustain discharge in a related art plasma display panel driving.

FIG. 2 illustrates the drive waveform generated in the driver in FIG. 1.

FIG. 3 is a drawing showing the driving waveform generated by the driver of the plasma display panel according to the present invention.

FIG. 4 is a drawing showing an example of the driver of the plasma display panel according to the present invention.

FIG. 5 is a timing diagram of the driving waveform generated by the driver of the plasma display panel according to the present invention.

FIGS. 6 through 13 are the drawing showing the energy supplying route for the timing diagram of the drive waveform of the plasma display panel according to the present invention.

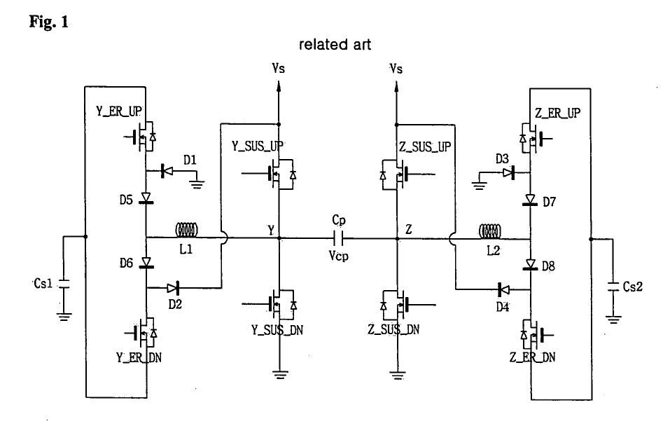

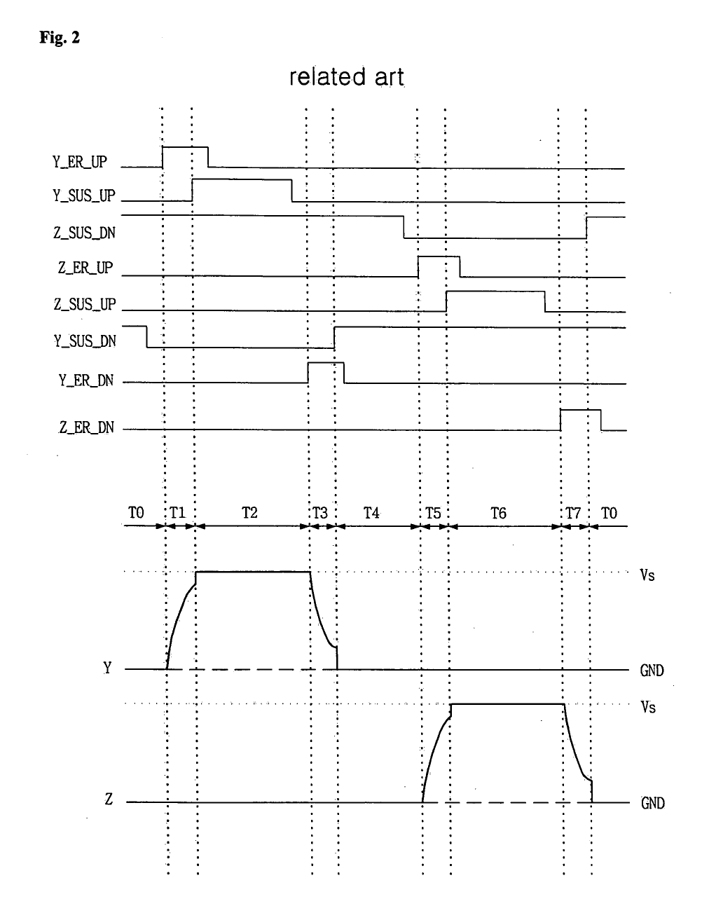

### DETAILED DESCRIPTION OF PREFERRED EMBODIMENTS

Preferred embodiments of the present invention will be described in a more detailed manner with reference to the drawings.

A plasma display apparatus according to an aspect of the present invention comprises a plasma display panel comprising a scan electrode and a sustain electrode; and a driver for applying energy to the scan electrode and the sustain electrode through an energy recovery path.

The driver comprises a first energy supply controller connecting the energy recovery path to the scan electrode; and a second energy supply controller connecting the energy recovery path to the sustain electrode.

The energy recovery path comprises a common inductor for resonance to recover energy; an energy recovery controller for switching to recover energy; and a common capacitor for storing the recovered energy.

The energy recovery path comprises an excess current breaker for maintaining a sustain voltage level when energy is applied to the panel.

The first energy supply controller is turned on, when the scan electrode is driven, for applying energy stored in the capacitor to the scan electrode.

The second energy supply controller is turned on, when the sustain electrode is driven, for applying energy stored in the capacitor to the sustain electrode.

A ground voltage is applied to the sustain electrode when a sustain pulse is applied to the scan electrode.

A ground voltage is applied to the sustain electrode when a sustain pulse is applied to the scan electrode.

The the first energy supply controller and the second energy supply controller are switching means comprising a diode.

The energy recovery controller is a switching means comprising a diode.

The common capacitor stores energy corresponding to approximately a half of a sustain voltage.

A plasma display apparatus according to another aspect of the present invention comprises a plasma display panel comprising a scan electrode and a sustain electrode; an energy recovery unit applying energy to the scan electrode and the sustain electrode through an energy recovery path; a first energy supply controller connecting the energy recovery unit to the scan electrode; and a second energy supply controller connecting the energy recovery unit to the sustain electrode.

The energy recovery path comprises a common inductor for resonance to recover energy; an energy recovery controller for switching to recover energy; and a common capacitor for storing the recovered energy.

The first energy supply controller and the second energy supply controller are switching means comprising a diode.

The energy recovery controller is a switching means comprising a diode.

A method of driving plasma display apparatus according to still another aspect of the present invention comprises applying energy stored in a common capacitor of an energy recovery part to a scan electrode through an inductor of the energy recovery part; applying a sustain voltage to the scan electrode from a scan voltage source; storing energy into the common capacitor of the energy recovery part by recovering energy applied in the scan electrode; and applying energy stored in the common capacitor of the energy recovery part to the sustain electrode through the inductor of the energy recovery part.

The energy recovery part comprises a switching means including a diode.

The energy recovery path is connected to the scan electrode by a first energy supply controller.

The energy recovery path is connected to the sustain electrode by a second energy supply controller.

The common capacitor stores energy corresponding to approximately a half of the sustain voltage.

Hereinafter, referring to the attached figure, the concrete embodiment is illustrated.

So as to help the clear understanding of the drive waveform for operating the plasma display apparatus, an example of the driving waveform of the plasma display apparatus will be described.

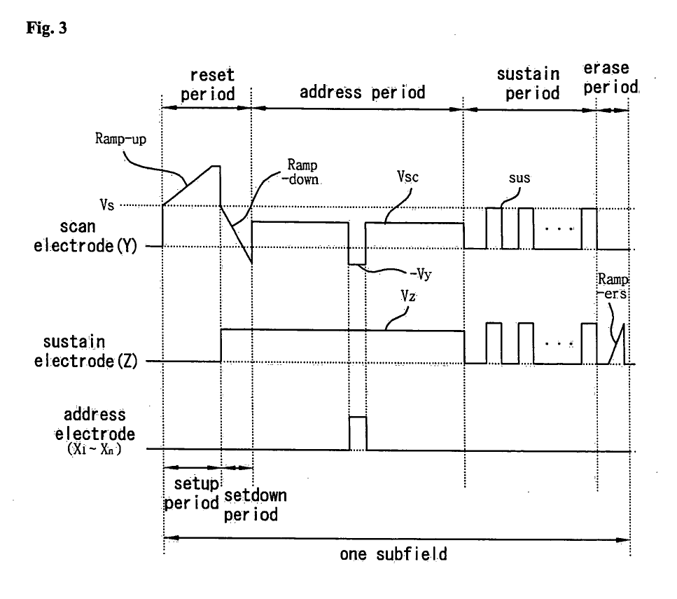

FIG. 3 is a drawing showing the driving waveform generated by the driver of the plasma display panel according to the present invention.

As shown in FIG. 3, the plasma display panel is driven by time-dividing a subfield of a frame into a reset period for initializing all cells, an address period for selecting a cell to be discharged, a sustain period for maintaining the discharge of the selected cell and an erase period for erasing wall charges within the discharged cell.

In the reset period, the ramp-up waveform Ramp-up is simultaneously applied to all scan electrodes Y1˜Ym during the set-up period. A weak dark discharge occurs due to the ramp-up waveform within the discharge cells of the full screen. Due to the setup address, a positive wall charges are accumulated on the address electrode X1˜Xn and sustain electrode, while negative wall charges are accumulated on the scan electrode Y1˜Ym.

In the set-down period, after the ramp-up waveform is supplied, the ramp-down waveform falls down from the positive voltage lower than the peak voltage of the ramp-up waveform to the specific voltage level less than the ground GND level voltage, causing the weak erasing discharge within the cells to sufficiently erase wall charges which are excessively formed in the scan electrode Y1˜Ym. Due to the setdown address, wall charges for stable address discharge are uniformly remained within cells.

In the address period, the negative scan pulse −Vy is successively applied to scan electrode Y1˜Ym. At the same time, synchronized to the scan pulse, the positive data pulse is applied to the address electrode X1˜Xn. When the voltage difference of the scan pulse and data pulse is added to the wall voltage generated in reset period, the address discharge is generated within the discharge cell in which data pulse is applied. The wall charges that are enough to generate a discharge when the sustain voltage Vs is applied is formed within cells selected by the address discharge. The positive voltage Vz is supplied the sustain electrode Z so that the misdischarge with the scan electrode Y1˜Ym may not occur by reducing the voltage difference with the scan electrode Y1˜Ym from the set-down period to the address period or during the address period.

In the sustain period, the sustain pulse Sus is alternately applied to the scan electrode Y1˜Ym and sustain electrode Z. In the cell selected by the address discharge, the sustain discharge, that is, the display discharge occurs between the scan electrode Y1˜Ym and sustain electrode Z whenever each sustain pulse is applied, while the wall voltage are added to sustain pulse. After the sustain discharge is completed, in the erase period, the voltage of the erase ramp waveform Ramp-ers having small pulse width and voltage level is supplied to the sustain electrode so that the wall charges remained within the cells of the full screen is erased.

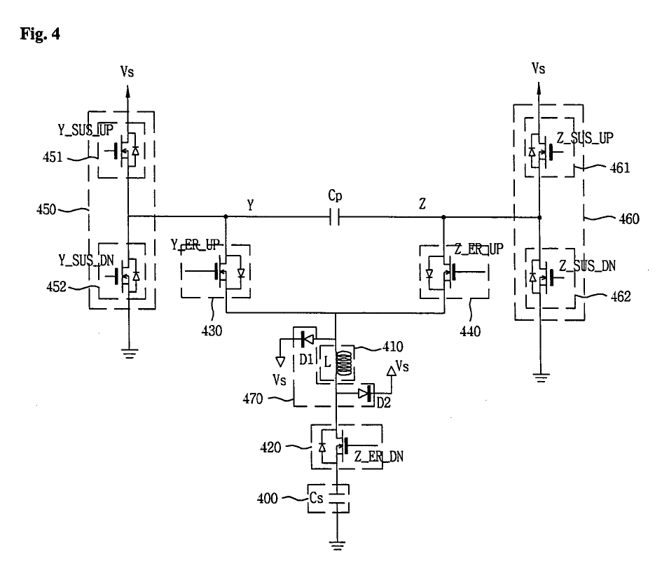

In an example of the drive waveform of the plasma display panel, the plasma display apparatus according to the present invention has a driver for driving the sustain pulse applied in the sustain period. In FIG. 4, an example of the driver for the sustain discharge of the plasma display panel of the present invention will be described in detail

FIG. 4 is a drawing showing an example of the driver of the plasma display panel according to the present invention.

As shown in FIG. 4, the driver for the sustain discharge of the plasma display apparatus according to the present invention drives the scan electrode Y and sustain electrode Z. In this case, the energy recovery circuit is used in order to collect the energy gratuitously generated in the plasma display panel, that is, the reactive power.

An example of the driver of the plasma display panel of the present invention includes the energy recovery circuit which supplies the energy to the panel Cp and collects the energy from the panel Cp. The energy recovery circuit includes a common energy storage 400, a common inductor part 410, an energy recovery controller 420, a first energy controller 430, a second energy controller 440, a first pulse controller 450 and a second pulse controller 460.

The common energy storage 400 includes a capacitor Cs for supplying and collecting energy in which the energy for the sustain discharge is stored. One end of the capacitor Cs for supplying and collecting energy is connected to the ground GND and the other end is connected to one end of the energy recovery controller 420. It is preferable that the capacity of capacitor Css for supplying and collecting energy is Vs/2.

Moreover, in the plasma display apparatus of the present invention, the capacitor Cs of the energy storage 400 is commonly used for the scan electrode Y and sustain electrode Z. Hence, when the scan electrode Y is driven, the energy of the panel Cp is collected and supplied through the scan electrode Y. When the sustain electrode Z is driven, the energy of the panel Cp is collected and supplied through the sustain electrode Z.

The energy recovery controller 420 includes the ER DN switching element. One end of the ER DN switching element is connected to the common energy storage 400, while the other end is connected to the other end of the common inductor part. Moreover, when the ER DN switching element is turned on, the voltage component of the reactive power is collected in the capacitor Cs for supplying and collecting energy of the common energy storage 400 on the sustain discharge.

In this case, in the plasma display apparatus of the present invention, the ER DN switching element of the energy recovery controller 420 is commonly used for the scan electrode Y and sustain electrode Z. Hence, when the scan electrode Y is driven, the energy of the panel Cp is collected through the scan electrode Y, while, when the sustain electrode Z is driven, the energy of the panel Cp is collected through the sustain electrode Z.

Moreover, in the plasma display apparatus of the present invention, the energy recovery controller 420 can rectify the current flowing from the capacitor Cs towards the panel Cp via the energy recovery controller 420 through the intrinsic diode of the ER DN switching element, without any additional diode for rectifying. Moreover, when the ER DN switching element is the field effect transistor FET device, a diode may be inserted between the drain and source to perform rectifying action.

As to the common inductor part 410, one end is commonly connected the other end of the first energy controller 430 and the other end of the second energy controller 440, while the other end is connected to the other end of the energy recovery controller 420. As a result, the common inductor part 410 and the panel Cp form a series LC resonance circuit._Therefore, when the energy stored in the common energy storage 400 is supplied to the panel Cp by the first energy controller 430 or the second energy controller 440, the panel Cp is charged with the resonance wave form supplied via the common inductor part 410 till the sustain voltage Vs. Moreover, when the energy of the panel Cp is collected to the common energy storage 400, the reactive power recovery path is formed as Z ER DN switching element of the energy recovery controller 420 is turned on. Therefore, the common energy storage 400 is charged with the energy with the voltage component of the reactive power collected via the common inductor part 410.

The common inductor part 410 is commonly used for the scan electrode Y and the sustain electrode Z like the common energy storage 400 and the energy recovery controller 420.

The first energy controller 430 includes Y ER UP switching element. One end of the Y ER UP switching element is commonly connected to the scan electrode Y, a first sustain voltage application part 451 and a first GND supply control part 452 of the first pulse controller 450, while the other end of the Y ER UP switching element is commonly connected to one end of the common inductor part 410 and to the other end of the second energy controller 440. Y ER UP switching element is turned on when the scan electrode Y is driven, supplying the energy stored in the capacitor Cs of the common energy storage 400 to the panel Cp through the scan electrode Y.

Moreover, in the plasma display apparatus of the present invention, the first energy controller 430 can rectify the current flowing from the panel Cp towards the capacitor Cs via the first energy controller 430 through the intrinsic diode of the Y_ER_UP switching element, without any additional diode for rectifying. Moreover, when the Y_ER_UP switching element is the field effect transistor FET device, a diode may be inserted between the drain and source to perform rectifying action.

The second energy controller 440 includes Z ER UP switching element. One end of the Z_ER_UP switching element is commonly connected to the sustain electrode Z, a second sustain voltage application part 461 and a second GND supply control part 462 of the second pulse controller 460, while the other end of the Z_ER_UP switching element is commonly connected to one end of the common inductor part 410 and to the other end of the first energy controller 430. Z_ER_UP switching element is turned on when the sustain electrode Z is driven, supplying the energy stored in the capacitor Cs of the common energy storage 400 to the panel Cp through the sustain electrode Z.

Moreover, in the plasma display apparatus of the present invention, the second energy controller 440 can rectify the current flowing from the panel Cp towards the capacitor Cs via the second energy controller 440 through the intrinsic diode of the Z _ER_UP switching element, without any additional diode for rectifying. Moreover, when the Z _ER_UP switching element is the field effect transistor FET device, a diode may be inserted between the drain and source to perform rectifying action.

The first pulse controller 450 includes the first sustain voltage application part 451 and the first GND supply control part 452.

The first sustain voltage application part 451 includes Y SUS UP switching element. One end of the Y SUS UP switching element is connected to the voltage source supplying the sustain voltage Vs, while the other end of the Y SUS UP switching element of Y SUS UP switching element is commonly connected to one end of the first energy controller 430 and to the other end of scan electrode Y and the first GND supply control part 452. Y SUS UP switching element of the first sustain voltage application part 451 is turned on when the energy charged in the panel Cp reaches the sustain voltage Vs during scan electrode Y driving, maintaining the sustain voltage Vs in the panel Cp.

The first GND supply control part 452 includes Y SUS DN switching element. One end of the first GND supply control part 452 is connected to the ground GND, while the other end of first GND supply control part 452 is commonly connected to the other end of the first sustain voltage application part 451 and to one end of the scan electrode Y and the first energy controller 430. Y SUS DN switching element of the first GND supply control part 452 is turned on after the common energy storage 400 is charged to the Vs/2 during the scan electrode Y driving. Thus, the panel Cp maintains 0V that the ground voltage source GND supplies. Moreover, Y SUS DN switching element is turned on during the sustain electrode Z driving, maintaining the scan electrode Y in the GND during the sustain electrode Z driving.

The second pulse controller 460 includes the second sustain voltage application part 461 and the second GND supply control part 462.

The second sustain voltage application part 461 includes Z SUS UP switching element. One end of the Z SUS UP switching element is connected to the voltage source supplying the sustain voltage Vs, while the other end of the Z SUS UP switching element is commonly connected to one end of the second energy controller 440 and to the other end of sustain electrode Z and the second GND supply control part 462. Z SUS UP switching element of the second sustain voltage application part 461 is turned on when the energy charged in the panel Cp reaches the sustain voltage Vs during sustain electrode Z driving, maintaining the sustain voltage Vs in the panel Cp.

The second GND supply control part 462 includes Z SUS DN switching element. One end of the second GND supply control part 462 is connected to the ground GND, while the other end of second GND supply control part 462 is commonly connected to the other end of the second sustain voltage application part 461 and to one end of the sustain electrode Z and the second energy controller 440. Z SUS DN switching element of the second GND supply control part 462 is turned on after the common energy storage 400 is charged to the Vs/2 during the sustain electrode Z driving. Thus, the panel Cp maintains 0V that the ground voltage source GND supplies. Moreover, Z SUS DN switching element is turned on during the scan electrode Y driving, maintaining the sustain electrode Z in the GND during the scan electrode Y driving.

Moreover, an excess-current cut-off part 470 may be included in the driver for operating the plasma display panel of the present invention, which is capable of maintaining the sustain voltage level Vs. The excess-current cut-off part 470 can be connected to either one end or the other end of the inductor part 410. Further, it can be connected to both one end and the other end of the inductor part 410. The excess-current cut-off part 470 maintains the sustain voltage level Vs by controlling an overpotential due to the counter electromotive force which is generated by suddenly changing the direction of the current flowing in the inductor part 410. Accordingly, the stability of the circuit operation is improved.

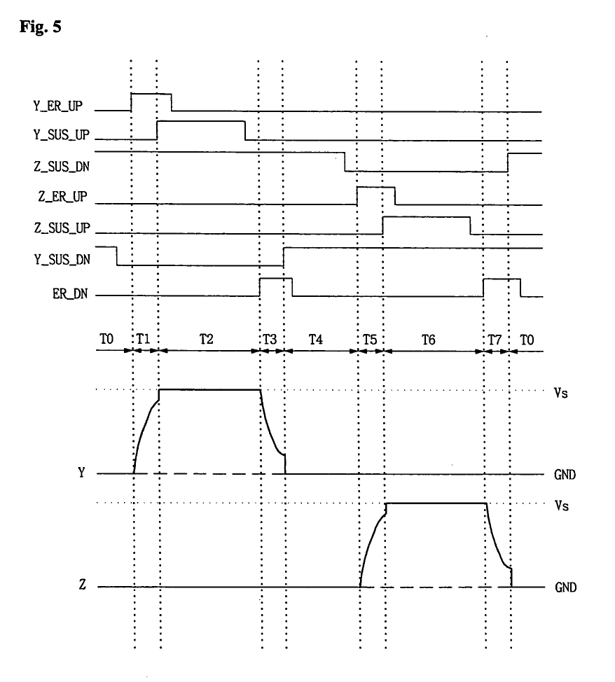

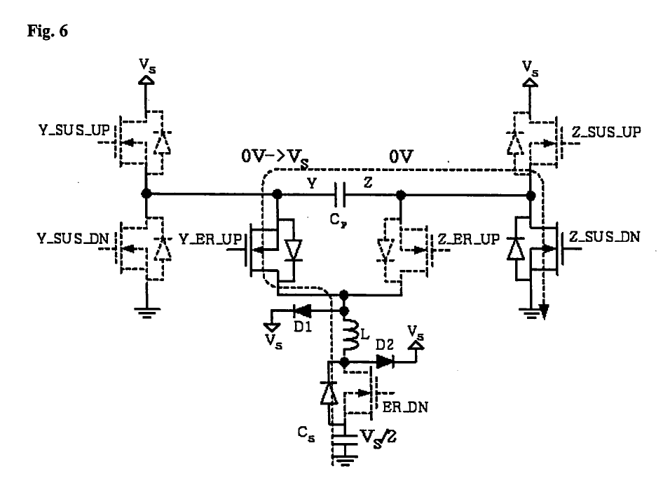

FIG. 5 showing the timing diagram of the drive waveform according to the driving method of an example of the plasma display driving apparatus according to the present invention is referred to. The driving method of the plasma display apparatus of the invention associated with the FIGS. 6 through 13 expressing the energizing pathway according to below driving method is made clear.

FIG. 5 is a timing diagram of the drive waveform that it is generated by the driver of the plasma display panel according to the present invention.

FIGS. 6 through 13 are the drawings showing the energizing pathway according to the timing diagram of the drive waveform of the plasma display panel according to the present invention. As to the switch turned on, it is illustrated as solid line, while the switch turned off is illustrated as dotted line.

Z SUS DN switch of FIG. 6 is turned on to maintain the sustain electrode Z in GND in order to operate the scan electrode Y, from the 0 period T0 till the fourth period T4 of FIG. 5.

Then, in order to applay the sustain pulse to the scan electrode Y, in the first period T1 of FIG. 5, as shown in FIG. 6, Y ER UP switch is turned on and all of the other switches except Y ER UP switch and Z SUS DN switch are turned off. Accordingly, the reactive power which the capacitor Cs commonly used for the scan electrode Y and sustain electrode Z collects and stores forms the resonance between the inductor L and capacitor Cp, being supplied to the scan electrode Y to charge the panel Cp. In this case, by commonly using the inductor L in the scan electrode Y and sustain electrode Z like the capacitor Cs, the number of devices can be reduced.

Moreover, the intrinsic diode of the ER DN switch of FIG. 6 rectifies the current flowing from the capacitor Cs for supplying and collecting energy towards the panel Cp via the ER DN switch. Therefore, the device number and the cost can be reduced without any additional diode for rectifying current. Moreover, when the ER DN switch is a field effect transistor FET device, a diode is inserted between the drain and source for rectifying current.

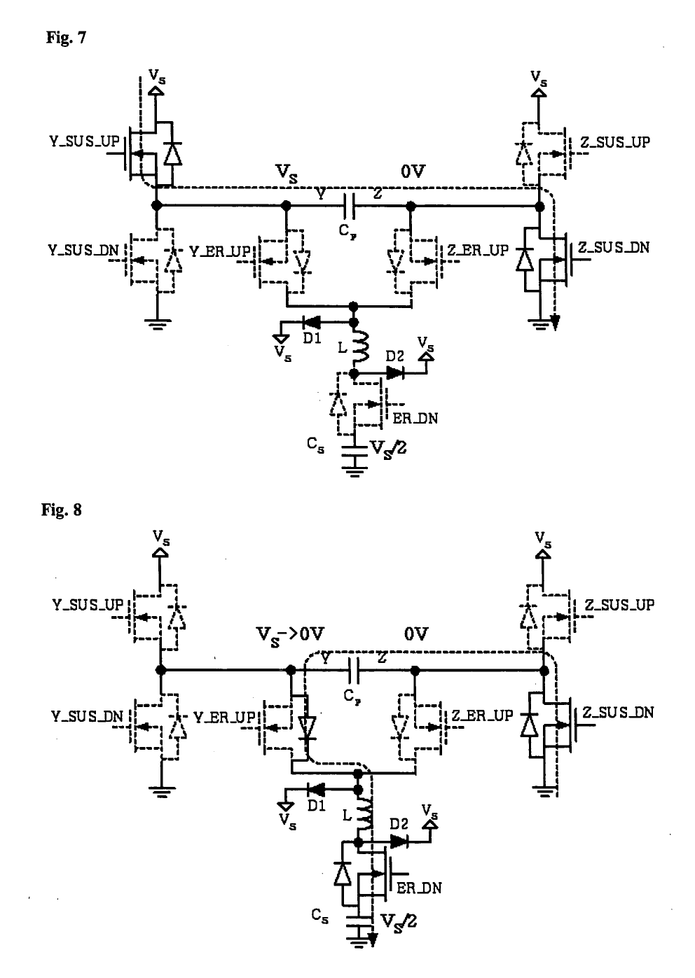

In the second period T2 of the FIG. 5, as shown in FIG. 7, when Y SUS UP switch is turned on and the waveform maintains the sustain voltage Vs, Y ER UP switch is turned off. All the other switches except Y SUS UP switch and Z SUS DN switch are turned off. Accordingly, the voltage of the panel Cp becomes the sustain voltage Vs. That is, when the first period T1 is finished, at the moment when the voltage of the panel becomes a maximum due to the LC resonance, the sustain voltage Vs is applied to the panel Cp. The sustain voltage Vs means the voltage for maintaining the discharge of the discharge cell in the sustain period.

Thereafter, as shown in FIG. 8, in the third period T3 of FIG. 5, the ER DN switch is turned on, while all the other switches except ER DN switch and Z SUS DN switch are turned off. Accordingly, while the energy stored in the panel Cp is discharged to the capacitor Cs through the scan electrode Y, the energy is collected and the voltage of the panel falls. In this case, in the plasma display apparatus according to the present invention, the number of devices can be reduced by commonly using the ER DN switch in the scan electrode Y and sustain electrode Z.

Moreover, in FIG. 8, the intrinsic diode of Y ER UP switch rectifies the current flowing from the panel Cp towards the capacitor Cs via Y ER UP switch. Therefore, the device number and the cost can be reduced without any additional diode for rectifying current. Moreover, when Y ER UP switch is a field effect transistor FET device, a diode is inserted between the drain and source for rectifying current.

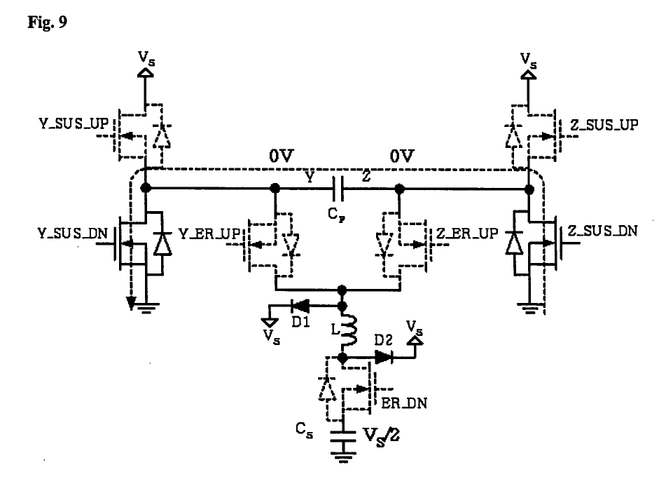

Finally, as shown in FIG. 9, in the fourth period T4 of FIG. 5, Y SUS DN switch is turned on and Z SUS DN switch maintains the turn on till the latter part of the fourth period. Moreover, all the other switches except Y SUS DN switch and Z SUS DN switch are turned off. Accordingly, the voltage of the panel is levelled with GND. That is, the voltage of both ends of the panel is set to maintain GND from the moment in which the third period T3 is finished to the fourth period T4. Thus, there are an idle period between the scan electrode Y driving and the sustain electrode Z driving so that an reciprocal interference between the electrodes can be reduced.

So as to apply the sustain pulse to the sustain electrode Z, from the fourth period T4 to the seventh period T7 or to the 0 period T0 before operating the following scan electrode Y driving in FIG. 5, Y SUS DN switch is turned on for driving the sustain electrode Z, so that the scan electrode Y maintains GND.

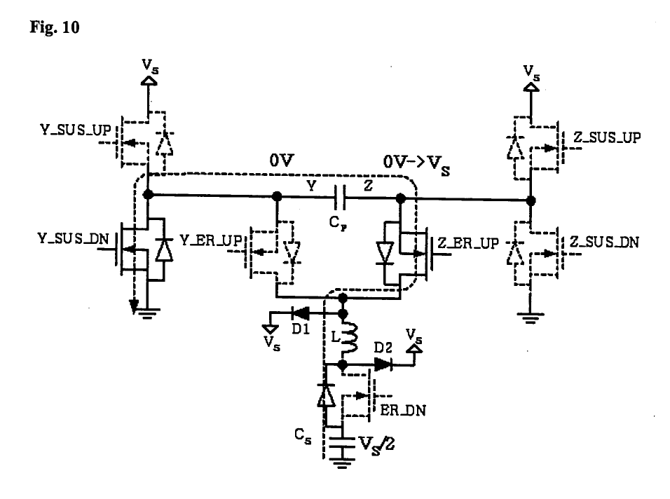

As shown in FIG. 10, in the fifth period T5 of FIG. 5, Z ER UP switch is turned on and all the other switches except Z ER UP switch and Y SUS DN switch are turned off. Accordingly, the energy of the reactive power which the capacitor Cs commonly used for the scan electrode Y and sustain electrode Z collects and stores forms the resonance between the inductor L and the capacitor Cp of the panel, being supplied from the scan electrode Y to the sustain electrode z to charge the panel Cp. In this case, the inductor L is commonly used in the scan electrode Y and sustain electrode Z like the capacitor Cs to reduce the number of devices.

Moreover, in FIG. 10, the intrinsic diode of Y ER DN switch rectifies the current flowing from the capacitor Cs towards the panel Cp via Y ER DN switch. Therefore, the device number and the cost can be reduced without any additional diode for rectifying current. Moreover, when Y ER DN switch is a field effect transistor FET device, a diode is inserted between the drain and source for rectifying current.

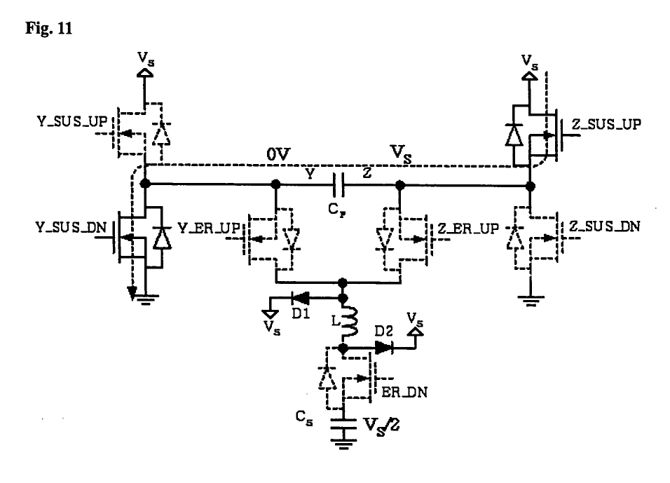

In the sixth period T6 of the FIG. 5, as shown in FIG. 11, when Z SUS UP switch is turned on and the waveform maintains the sustain voltage Vs, Z ER UP switch is turned off. All the other switches except Z SUS UP switch and Y SUS DN switch are turned off. Accordingly, the voltage of the panel becomes the sustain voltage Vs. That is, when the fifth period T5 is finished, at the moment when the voltage of the panel becomes a maximum due to the LC resonance, the sustain voltage Vs is applied to the panel Cp. The sustain voltage Vs means the voltage for maintaining the discharge of the discharge cell in the sustain period.

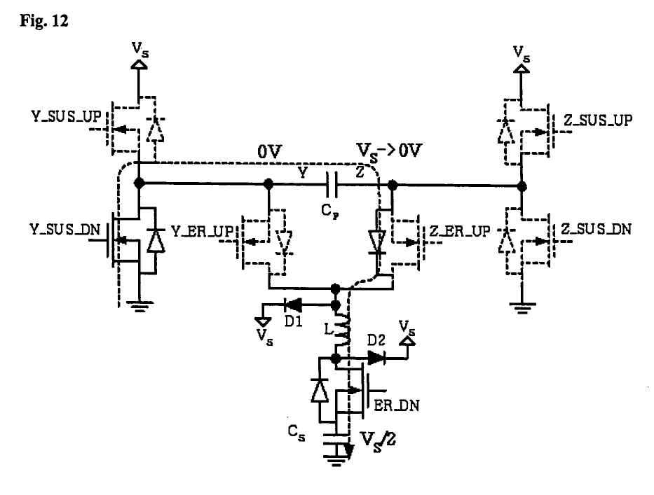

Thereafter, as shown in FIG. 12, in the seventh period T7 of FIG. 5, the ER DN switch is turned on, while all the other switches except ER DN switch and Y SUS DN switch are turned off. Accordingly, while the energy stored in the panel Cp is discharged to the capacitor Cs through the sustain electrode Z, the energy is collected and the voltage of the panel falls. In this case, in the plasma display apparatus according to the present invention, the number of devices can be reduced by commonly using the ER DN switch in the scan electrode Y and sustain electrode Z.

Moreover, in FIG. 12, the intrinsic diode of Z ER UP switch rectifies the current flowing from the panel Cp towards the capacitor Cs via Z ER UP switch. Therefore, the device number and the cost can be reduced without any additional diode for rectifying current. Moreover, when Z ER UP switch is a field effect transistor FET device, a diode is inserted between the drain and source for rectifying current.

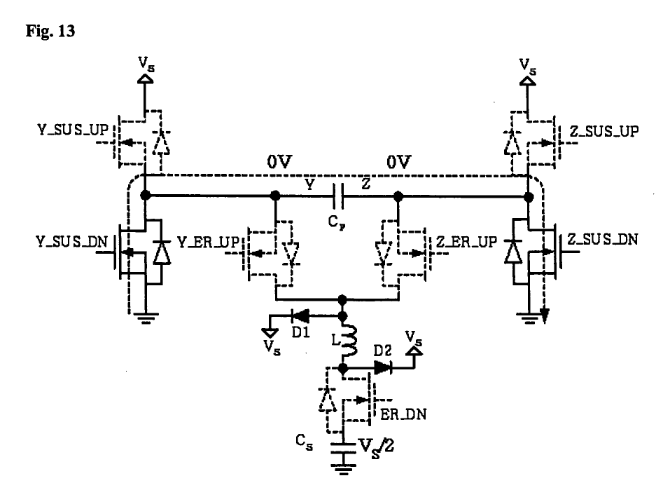

Thereafter, the 0 period T0 of FIG. 5 of the idle period is initiated before driving the scan electrode Y again. As shown in FIG. 13, in the 0 period, Z SUS DN switch is turned on and Y SUS DN switch maintains the turn on till the latter part of the 0 period. Moreover, all the other switches except Y SUS DN switch and Z SUS DN switch are turned off. Accordingly, the voltage of the panel is levelled with GND. That is, the voltage of both ends of the panel is set to maintain GND from the moment in which the seventh period T7 is finished to the 0 period T0. Thus, there are an idle period between the scan electrode Y driving and the sustain electrode Z driving so that an reciprocal interference between the electrodes can be reduced.

Moreover, in the driving method of the plasma display apparatus according to the present invention, preferably the diode D1, D2 shown in FIG. 13 play the role of maintaining the sustain voltage level Vs. That is, they control the overpotential due to the counter electromotive force generated by suddenly changing the direction of the current flowing in the inductor L, maintaining the sustain voltage level Vs. Thus, it is capable of improving the stability of the circuit operation.

The plasma display apparatus of the present invention described in the above can be applied to the driver circuit where the scan electrode Y and sustain electrode Z are united.

Moreover, it has the effect that the number of circuit elements are drastically reduced by using a common circuit element in the scan electrode Y and sustain electrode Z, the manufacturing cost is saved.

In addition, without any additional device for rectifying action, the excess current can be blocked through the intrinsic diode of the switch element. As a result, the element number is reduced, improving the stability of the circuit operation.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode and a sustain electrode; and
a driver for applying energy to the scan electrode and the sustain electrode through an energy recovery path.

2. The plasma display apparatus of claim 1,
wherein the driver comprises
a first energy supply controller connecting the energy recovery path to the scan electrode; and
a second energy supply controller connecting the energy recovery path to the sustain electrode.

3. The plasma display apparatus of claim 1,
wherein the energy recovery path comprises:
a common inductor for resonance to recover energy;
an energy recovery controller for switching to recover energy; and
a common capacitor for storing the recovered energy.

4. The plasma display apparatus of claim 1,
wherein the energy recovery path comprises an excess current breaker for maintaining a sustain voltage level when energy is applied to the panel.

5. The plasma display apparatus of claim 2,
wherein the first energy supply controller is turned on, when the scan electrode is driven, for applying energy stored in the capacitor to the scan electrode.

6. The plasma display apparatus of claim 2,
wherein the second energy supply controller is turned on, when the sustain electrode is driven, for applying energy stored in the capacitor to the sustain electrode.

7. The plasma display apparatus of claim 1,
wherein a ground voltage is applied to the sustain electrode when a sustain pulse is applied to the scan electrode.

8. The plasma display apparatus of claim 1,
wherein a ground voltage is applied to the sustain electrode when a sustain pulse is applied to the scan electrode.

9. The plasma display apparatus of claim 2,
wherein the first energy supply controller and the second energy supply controller are switching means comprising a diode.

10. The plasma display apparatus of claim 3,
wherein the energy recovery controller is a switching means comprising a diode.

11. The plasma display apparatus of claim 3,
wherein the common capacitor stores energy corresponding to approximately a half of a sustain voltage.

12. A plasma display apparatus comprising:
a plasma display panel comprising a scan electrode and a sustain electrode;
an energy recovery unit applying energy to the scan electrode and the sustain electrode through an energy recovery path;
a first energy supply controller connecting the energy recovery unit to the scan electrode; and
a second energy supply controller connecting the energy recovery unit to the sustain electrode.

13. The plasma display apparatus of claim 12,
wherein the energy recovery path comprises:
a common inductor for resonance to recover energy;
an energy recovery controller for switching to recover energy; and
a common capacitor for storing the recovered energy.

14. The plasma display apparatus of claim 12,
wherein the first energy supply controller and the second energy supply controller are switching means comprising a diode.

15. The plasma display apparatus of claim 13,
wherein the energy recovery controller is a switching means comprising a diode.

16. A method of driving plasma display apparatus, the method comprising:
applying energy stored in a common capacitor of an energy recovery part to a scan electrode through an inductor of the energy recovery part;
applying a sustain voltage to the scan electrode from a scan voltage source;
storing energy into the common capacitor of the energy recovery part by recovering energy applied in the scan electrode; and
applying energy stored in the common capacitor of the energy recovery part to the sustain electrode through the inductor of the energy recovery part.

17. The method of claim 16,
wherein the energy recovery part comprises a switching means including a diode.

18. The method of claim 16,
wherein the energy recovery path is connected to the scan electrode by a first energy supply controller.

19. The method of claim 16,
wherein the energy recovery path is connected to the sustain electrode by a second energy supply controller.

20. The method of claim 16,
wherein the common capacitor stores energy corresponding to approximately a half of the sustain voltage.
